(19) United States
(12) Patent Application Publication
(10) Pub. No.: US 2006/0139808 A1
(43) Pub. Date: Jun. 29, 2006

(54) Head slider and hard disk drive including the same

(75) Inventors: Sung-chul Kim, Suwon-si (KR); Keung-Youn Cho, Namyangju-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/294,462

(22) Filed: Dec. 6, 2005

(30) Foreign Application Priority Data
Dec. 28, 2004 (KR) 10-2004-0113693

(51) Int. Cl. G11B 5/60

(52) U.S. Cl. 360/234.3

(57) ABSTRACT

A head slider, and a hard disk drive having the head slider, the head slider including a slider body; a magnetic head provided on the slider body, the magnetic head including a writer to write data on a disk and a reader to read data written on the disk; and a shield layer to prevent penetration of an external magnetic field.

### CROSS-REFERENCE TO RELATED APPLICATIONS

This application claims the benefit of Korean Patent Application No.10-2004-0113693, filed on Dec. 28, 2004, in the Korean Intellectual Property Office, the disclosure of which is incorporated herein by reference.

### BACKGROUND OF THE INVENTION

1. Field of the Invention

The present invention relates to a hard disk drive (HDD), and, more particularly, to a head slider for which malfunction due to an external magnetic field is prevented, and an HDD including the head slider.

2. Description of the Related Art

Hard disk drives (HDDs), which are auxiliary memory devices for computers, reproduce data stored on a disk, or record new data on the disk, using a magnetic head. The magnetic head is mounted on a head slider. During operation of the HDD, the head slider is kept at a predetermined flying height over the disk, and the magnetic head reads data stored on the disk, or writes new data on the disk.

FIG. 1 is a sectional view illustrating a conventional head slider.

Referring to FIG. 1, the head slider 10 includes a slider body 11 made of AITiC, and a magnetic head 20 mounted on a side of the slider body 11. The magnetic head 20 includes a writer 21 to write data on a disk (not shown), and a reader 25 to read data written on the disk. The writer 21 includes a first magnet 22 and a second magnet 23, which jointly form a magnetic core inside the magnetic head 20, and a coil 24 wound around the magnetic core. The reader 25 includes a first shield 26 and a second shield 27 arranged in parallel, and a magnetoresistance (MR) sensor 28 interposed between the pair of shields 26 and 27. The writer 21 and the reader 25 are covered by a protective layer 29 made of Al₂O₃. A surface of the head slider 10 facing the disk is provided with a diamond-like carbon (DLC) coating layer 13 to prevent damage which may result from contact between the head slider 10 and the disk.

In the meantime, if the head slider 10 is exposed to an external magnetic field M as illustrated by arrows in FIG. 1, the external magnetic field M may hamper a write field, which is generated by the writer 21 to write data on the disk, which in turn may lead to a malfunction. Also, the external magnetic field M may cause a malfunction of the MR sensor 28 in the reader 25.

With the recent trend of developing high density and compact HDDs, the HDDs are increasingly being provided in mobile phones and/or MP3 players. Accordingly, the possibility increases that an external magnetic field, caused by an external magnet or other such cause, may penetrate the HDDs. Therefore, there is a demand to prevent an external magnetic field that may cause malfunction of the magnetic head 20.

### SUMMARY OF THE INVENTION

The present invention provides a head slider for which malfunction due to an external magnetic field is prevented, and a hard disk drive (HDD) provided with the head slider.

Additional aspects and/or advantages of the invention will be set forth in part in the description which follows and, in part, will be apparent from the description, or may be learned by practice of the invention.

According to an aspect of the present invention, there is provided a head slider comprising: a slider body; a magnetic head provided on the slider body, the magnetic head including a writer to write data on a disk and a reader to read data written on the disk; and a shield layer to prevent penetration of an external magnetic field that causes malfunction of the writer and the reader.

The shield layer may be formed on an outer surface of the magnetic head.

The shield layer may not be formed on a surface of the magnetic head facing the disk.

The shield layer may comprise MUMETAL®.

The shield layer may comprise a material having a magnetic permeability higher than approximately 900μ.

According to another aspect of the present invention, there is provided a hard disk drive comprising: a disk; and a head slider to write data on the disk or read data written on the disk, wherein the head slider comprises: a slider body, a magnetic head provided on the slider body, the magnetic head including a writer to write the data on the disk and a reader to read the data written on the disk, and a shield layer to prevent penetration of an external magnetic field that causes malfunction of the writer and the reader.

The shield layer may be formed on an outer surface of the magnetic head.

The shield layer may not be formed on a surface of the magnetic head facing the disk.

The shield layer may comprise MUMETAL®.

The shield layer may comprise a material having a magnetic permeability higher than approximately 900μ.

According to another aspect of the present invention, there is provided a head slider comprising: a magnetic head to write data on a disk and/or read data from the disk; and a shield layer to prevent an external magnetic field from entering the head slider.

According to another aspect of the present invention, there is provided a head slider to write data to, and/or read data from, a disk, the head slider comprising: a magnetic head; and a protection member to counteract a magnetic field so that the magnetic field does not enter the magnetic head.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a sectional view illustrating a conventional head slider;

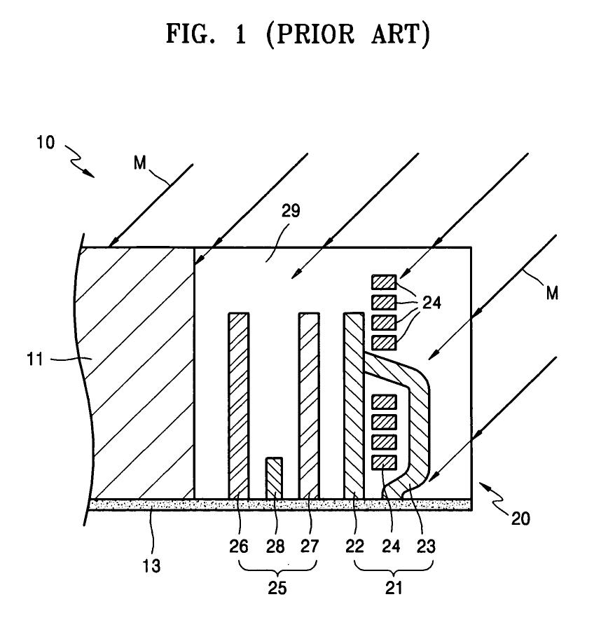

FIG. 2 is a top plan view illustrating a hard disk drive (HDD) according to an embodiment of the present invention;

FIG. 3 is a perspective view illustrating a head slider according to an embodiment of the present invention; and

FIG. 4 illustrates a sectional view taken along line IV-IV of FIG. 3.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

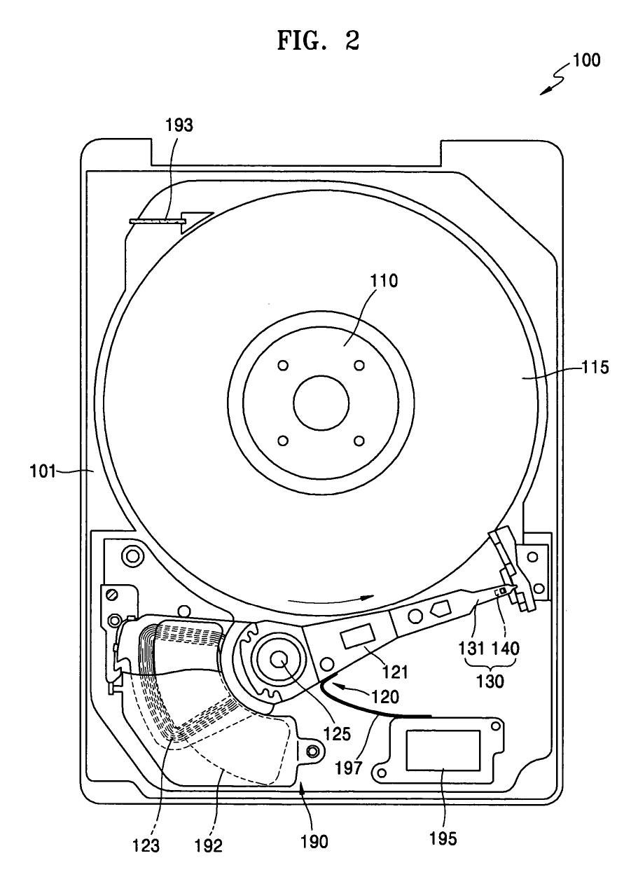

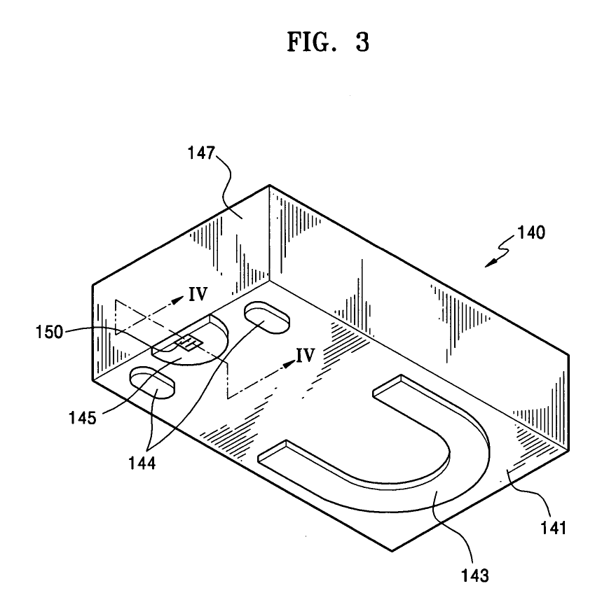

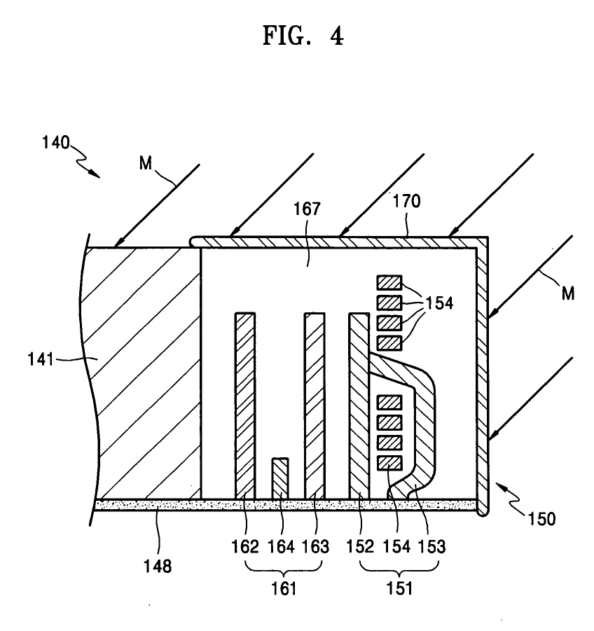

FIG. 2 is a top plan view illustrating a hard disk drive (HDD) according to an embodiment of the present invention. FIG. 3 is a perspective view illustrating a head slider according to an embodiment of the present invention. FIG. 4 illustrates a sectional view taken along line IV-IV of FIG. 3.

Referring to FIG. 2, an HDD 100 includes a base plate 101 and a cover plate (not shown) coupled together to form a housing, and also includes a spindle motor 110, at least one disk 115, an actuator 120, and a voice coil motor (VCM) 190 provided in the housing.

The spindle motor 110, used to rotate the disk 115, is fixed to the base plate 101. The disk 115 is coupled to a rotor (not shown) of the spindle motor 110, and rotates together with the rotor.

The actuator 120, on which a head slider 140 is provided, moves the head slider 140 to a predetermined position on the disk 115 to record data on the disk 115, or to reproduce data recorded on the disk 115. The actuator 120 includes a swing arm 121 and a head Gimbal assembly 130. The swing arm 121 is rotatably coupled to a pivot shaft 125 coupled to the base plate 101. The head Gimbal assembly 130 includes a suspension 131 fixed to a front end of the swing arm 121, and the magnetic head slider 140 coupled to, and supported on, a front end of the suspension 131. The suspension 131 elastically biases the magnetic head slider 140 toward a surface of the disk 115.

The VCM 190, provided to the base plate 101, provides torque to rotate the actuator 120. The VCM 190 includes magnets 192 disposed over and under a coil 123 of the actuator 120. The VCM 190 is controlled by a servo control system, and rotates the actuator 120 in a direction according to Fleming's Left Hand Rule due to an interaction between current input to the coil 123 and a magnetic field formed by the magnets 192.

A flexible printed circuit (FPC) bracket 195 may be disposed at a corner of the base plate 101 to connect an FPC 197 to a main circuit board (not shown) located under the base plate 101. Also, a recursive filter 193 may be disposed at a corner diagonal to the corner of the FPC bracket 195 to filter foreign substances such as particles in the air inside the HDD 100.

If the HDD 100 is turned on, the disk 115 rotates at a high speed, and the head slider 140 coupled to and supported on the suspension 131 is lifted to a predetermined height from the surface of the disk 115, and is kept floating due to a balance between a lifting force generated by airflow induced by the rotation of the disk 115 and an elastic force of the suspension 131 directed toward the surface of the disk 115. In this state, the actuator 120 moves the head slider 140 to a predetermined position on the disk 115 to write data on the disk 115, or read data from the disk 115.

Referring to FIGS. 3 and 4, the head slider 100 may include a slider body 141 made of AlTiC, and a magnetic head 150 provided on a side of the slider body 141. The magnetic head 150 may be provided on a trailing edge 147 from which the airflow induced by the rotation of the disk 115 (see FIG. 2) travels. A bottom surface of the head slider 140 facing the disk 115 may include air bearing surfaces 143, 144, and 145, and a diamond like carbon (DLC) coating layer 148 to prevent damage due to a contact between the head slider 140 and the disk 115.

The magnetic head 150 includes a writer 151 to write data on the disk 115, and a reader 161 to read data written on the disk 115. The writer 151 may include a first magnet 152 and a second magnet 153, which jointly form a magnetic core inside the magnetic head 150, and a coil 154 wound around the magnetic core. The first magnet 152 and the second magnet 153 may comprise a magnetic material such as FeNi. If an electric signal (referred to as a write signal hereinafter) corresponding to data to be written is applied from the main circuit board (not shown) of the HDD 100 to the coil 154, the magnetic flux of the first magnet 152 and the second magnet 153 changes, and the data is written on the disk 115 due to the change in the magnetic flux.

The reader 161 may include a first shield 162 and a second shield 163 arranged in parallel, and a magnetoresistance (MR) sensor 164 interposed between the pair of shields 162 and 163. The first shield 162 and the second shield 163 may be made of a magnetic material such as FeNi. An electric signal (referred to as a read signal) corresponding to data to be read is generated in the MR sensor 164 due to the change in the magnetic flux of the disk 115, and the read signal is transferred to the main circuit board of the HDD 100. Additionally, both the writer 151 and the reader 161 may be covered by a protective layer 167 made of Al₂O_{3.}

A shield layer 170 may be formed on the head slider 140 to protect the head slider 140 from an external magnetic field M, because the external magnetic field M may lead to malfunction of the writer 151 and the reader 161. Material with a high magnetic permeability of 900μ or more may be used in the shield layer that screens the external magnetic field M. For example, a nickel (Ni) alloy and an iron (Fe) alloy may be used as the material of the shield layer 170. In particular, MUMETAL®, which is a Ni—Fe alloy, has a high magnetic permeability, and thus can be preferably, though not necessarily, used as the material of the shield layer 170. The characteristics of the MUMETAL® may vary according to the relative proportions of compounds. In detail, a MUMETAL® composed of 77% nickel (Ni), 15% iron (Fe) plus copper (Cu) and molybdenum (Mo) may be used as the shield layer 170. The shield layer 170 may be formed by plating or coating.

The shield layer 170 may be formed on a top surface of the magnetic head 150 and an outer surface of the trailing edge 147. However, no shield layer is formed on a bottom surface of the magnetic head 150 facing the disk 115, so that there is no interference with an operation to write and/or read data.

Since an external magnetic field M, which may otherwise penetrate toward the head slider 140 through the HDD 100, is absorbed by the shield layer 170, it cannot penetrate into the magnetic head 150, thereby failing to hamper the writer 151 and the reader 161. Accordingly, malfunction of the writer 151 and the reader 161 due to the external magnetic field M is avoided.

Since the external magnetic field is prevented from penetrating into the magnetic head of the head slider, malfunction of the HDD during data write and read operations can be avoided.

The present invention is not limited to the embodiments discussed above. For example, the shield layer for preventing external magnetic field penetration may be formed on all outer surfaces of the head slider except the bottom surface.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A head slider comprising:
a slider body;
a magnetic head provided on the slider body, the magnetic head including a writer to write data on a disk and a reader to read data written on the disk; and
a shield layer to prevent penetration of an external magnetic field that causes malfunction of the writer and the reader.

2. The head slider of claim 1, wherein the shield layer is formed on an outer surface of the magnetic head.

3. The head slider of claim 1, wherein the shield layer is not formed on a surface of the magnetic head facing the disk.

4. The head slider of claim 1, wherein the shield layer comprises MUMETAL®.

5. The head slider of claim 1, wherein the shield layer comprises a material having a magnetic permeability higher than approximately 900μ.

6. A hard disk drive comprising:
a disk; and
a head slider to write data on the disk or read data written on the disk, wherein the head slider comprises:
a slider body,
a magnetic head provided on the slider body, the magnetic headincluding a writer to write the data on the disk and a reader to read the data written on the disk, and
a shield layer to prevent penetration of an external magnetic field that causes malfunction of the writer and the reader.

7. The hard disk drive of claim 6, wherein the shield layer is formed on an outer surface of the magnetic head.

8. The hard disk drive of claim 6, wherein the shield layer is not formed on a surface of the magnetic head facing the disk.

9. The hard disk drive of claim 6, wherein the shield layer comprises MUMETAL®.

10. The hard disk drive of claim 6, wherein the shield layer comprises a material having a magnetic permeability higher than approximately 900μ.

11. A head slider comprising:
a magnetic head to write data on a disk and/or read data from the disk; and
a shield layer to prevent an external magnetic field from entering the head slider.

12. The head slider of claim 11, wherein the shield layer is provided on an outer surface of the magnetic head.

13. The head slider of claim 11, wherein the shield layer surrounds the head slider except for a portion of the head slider facing the disk.

14. The head slider of claim 11, wherein the shield layer is provided on the head slider by plating or coating.

15. The head slider of claim 11, wherein the shield layer has a magnetic permeability greater than or equal to approximately 900μ.

16. The head slider of claim 11, wherein the shield layer comprises a nickel alloy.

17. The head slider of claim 11, wherein the shield layer comprises an iron alloy.

18. A head slider to write data to, and/or read data from, a disk, the head slider comprising:
a magnetic head; and
a protection member to counteract a magnetic field so that the magnetic field does not enter the magnetic head.
